(19) United States
(12) Patent Application Publication
(10) Pub. No.: US 2009/0216628 A1
(43) Pub. Date: Aug. 27, 2009

(54) CONFIGURABLE, QUESTIONNAIRE-BASED PROJECT ASSESSMENT

(75) Inventors: Anil Kumar Pandey, Maharashtra (IN); Anupam Pandey, Bangalore (IN)

Correspondence Address: Vedder Price PC, 222 NORTH LASALLE STREET, CHICAGO, IL, 60601, US

(73) Assignee: ACCENTURE GLOBAL SERVICES GmbH, Schaffhausen (CH)

(21) Appl. No.: 12/368,420

(22) Filed: Feb. 10, 2009

(30) Foreign Application Priority Data
Feb. 21, 2008 (IN) 377/MUM/2008

(51) Int. Cl. G06Q 10/00

(52) U.S. Cl. 705/11

(57) ABSTRACT

Project assessment is initiated with receipt of project specification data that is descriptive, among other things, of at least one skill set or domain applied to the project. Based on the project specification data, one or more questionnaires, each corresponding to one of the identified skill sets, are automatically selected. Each of the selected questionnaires comprises questions concerning best practices applicable to the corresponding one skill set. The identified questionnaires are provided to a user and, in turn, assessment data is received in response to the one or more questionnaires. Based on the assessment data, an overall project score and other scores can be determined and presented. The at least one skill set may identify specific technologies being applied to the project. Because the questions presented in the at least one questionnaire require standardized answers, results from among a plurality of reviewers may be compared more readily.

### FIELD OF THE INVENTION

The instant disclosure relates generally to project management techniques and, in particular, to techniques for assessing the health of a project.

### BACKGROUND OF THE INVENTION

As known in the art, successful project management includes periodic review and assessment of the personnel and procedures used to implement a specific project. Current approaches to such periodic reviews/assessments typically involve the use of reviewers attempting to manually complete review documents.

In this approach, each reviewer is asked to complete a form setting forth questions designed to capture the reviewer's opinion regarding some aspect of project-related performance. However, it is often the case that such forms include unstructured questions that allow for open-ended responses. As a result, the particular characteristics of each individual reviewer are more important than the process underlining the review. That is, because the responses provided by a reviewer are often subjective in nature, they are difficult to quantify and it becomes increasingly difficult, if not impossible to systematically compare responses from separate reviewers.

Furthermore, even where potential responses are normalized in some way, e.g., through the provision of a numeric scale having corresponding response values from one extreme to another and several response values in between the extremes, the questions asked are generic in nature. As a result, while the assessment results may suggest the existence of a problem, little insight is provided into the specific nature of the problem and, equally important, into possible solutions for resolving the problem. Any conclusions to be drawn from such review processes are by themselves necessarily subjective, therefore providing little assurance that the review process has accurately captured the current state of the project or suggested ways forward for improving the project.

It is therefore desirable to provide techniques for performing project reviews in a repeatable, reliable and automated fashion. Such techniques, in addition to identifying areas of potential problems, should be capable of suggesting solutions to such problems.

### SUMMARY OF THE INVENTION

The instant disclosure describes techniques for project assessment that substantially overcome the above-described limitations of prior art approaches. To this end, in one embodiment, project specification data is received, which data is descriptive, among other things, of at least one skill set or domain applied to the project. As used herein, a project includes any activity in which a group of project participants, typically having varying skill sets, are working to achieve a common goal. Based on the project specification data, one or more questionnaires, each corresponding to one of the identified skill sets, are automatically selected. Each of the selected questionnaires comprises questions concerning best practices applicable to the corresponding one skill set. The identified questionnaires are thereafter provided to a user, i.e., a reviewer, via a graphical user interface. In turn, assessment data is received, again via the graphical user interface, in response to the one or more questionnaires. Based on the assessment data, an overall project score can be determined and presented via the graphical user interface. Likewise, a descriptive assessment of the project based on overall project score can also be determined and presented. In one embodiment, the at least one skill set comprises identification of a specific technology being applied to the project. Furthermore, a project impact score may be determined based on that portion of the assessment data that is indicative of a failure to follow the best practices. Because the questions presented in the at least one questionnaire are developed to be answered using only a limited range of responses, e.g., “yes” or “no”, results from among a plurality of reviewers may be compared more readily. In one embodiment, the techniques described herein are implemented using stored instructions executed by one or more processors.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a block diagram of an apparatus suitable for implementing the various embodiments described herein;

FIG. 2 is a flowchart illustrating processing in accordance with the various embodiments described herein;

FIG. 3 is a block diagram illustrating a functional implementation in accordance with an embodiment described herein; and

FIGS. 4-7 illustrate examples of various screen shots in accordance with an embodiment of a graphical user interface described herein.

### DETAILED DESCRIPTION OF THE PRESENT EMBODIMENTS

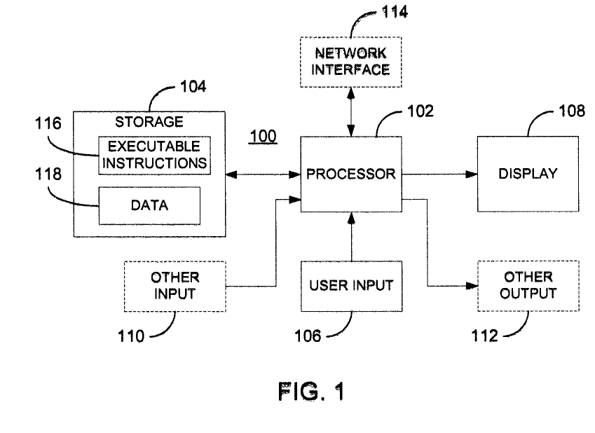

Referring now to FIG. 1, an example of an apparatus 100 that may be used to implement the various embodiments described herein is further illustrated. In particular, the device 100 comprises a processor 102 coupled to a storage component 104. The storage component 104, in turn, comprises stored, executable instructions 116 and data 118. In one embodiment, the processor 102 may comprise one or more processing devices such as a microprocessor, microcontroller, digital signal processor or combinations thereof capable of executing the stored instructions 116 and operating upon the stored data 118. Likewise, the storage component 104 may comprise one or more storage devices such as volatile or non-volatile memory including but not limited to random access memory (RAM), read-only memory (ROM), electrically-erasable programmable read-only memory (EEPROM), etc. Processor and storage arrangements of the type illustrated in FIG. 1 are well known to those having ordinary skill in the art, and various other suitable arrangements may be readily devised. In practice, the apparatus 100 may be embodied as, by way of non-limiting example, a desktop/laptop/handheld computer, a personal digital assistant, mobile communication device, etc. In a presently preferred embodiment, processing in accordance with the various embodiments described herein is preferably implemented as a combination of executable instructions 116 and data 118 stored within the storage component 104, i.e., using suitable software programming techniques. However, as known by those having ordinary skill in the art, such processing can also be implemented in whole or in part using other processing arrangements, such as suitably configured programmable logic arrays, application specific integrated circuits or the like.

In one embodiment, the apparatus 100 comprises one or more user input devices 106, a display 108, other input devices 110, other output devices 112 and a network interface 114, all in communication with the processor 102. The user input device 106 may comprise any mechanism for providing user input to the processor 102. For example, the user input device 106 may comprise a keyboard, a mouse, a touch screen, stylus or any other means known to those having ordinary skill in the art whereby a user of the apparatus 100 may provide input data to the processor 102. The display 108 may comprise any conventional display mechanism such as a cathode ray tube (CRT), flat panel display or any other similar display mechanism. Techniques for providing display data from the processor 102 to the display 108 are well known in the art.

The other (optional, as illustrated by the dashed lines) input devices 110 may include various media drives (such as magnetic disc or optical disc drives), a microphone or any other source of user-provided input data. Likewise, the other output devices 112 may optionally comprise similar media drive mechanisms as well as other devices capable of providing information to a user of the apparatus 100, such as speakers, LEDs, tactile outputs, etc. Finally, the network interface 114 may comprise hardware and/or software that allows the processor 102 to communicate with other devices via wired or wireless network, as known in the art. Using the network interface 114, the techniques of the present invention may be performed in a remote manner, for example, as in the case of a Web application service.

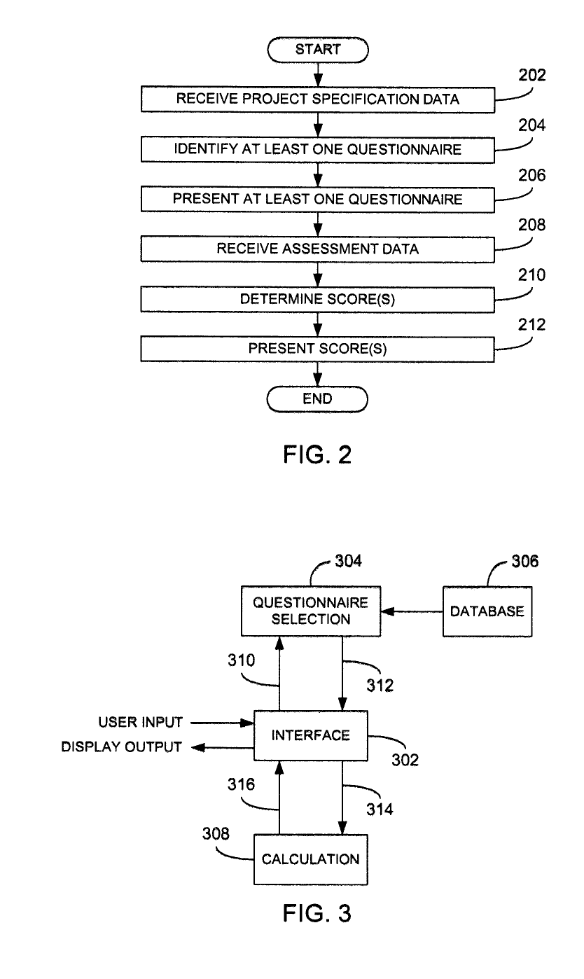

Referring now to FIG. 2, processing in accordance with an embodiment of the present invention is further described. The processing illustrated in FIG. 2 may be implemented using the apparatus 100 of FIG. 1. However, those having ordinary skill in the art will appreciate that the processing illustrated in FIG. 2 may be implemented using other approaches as described above, i.e., entirely using hardware components or a combination of hardware and software components.

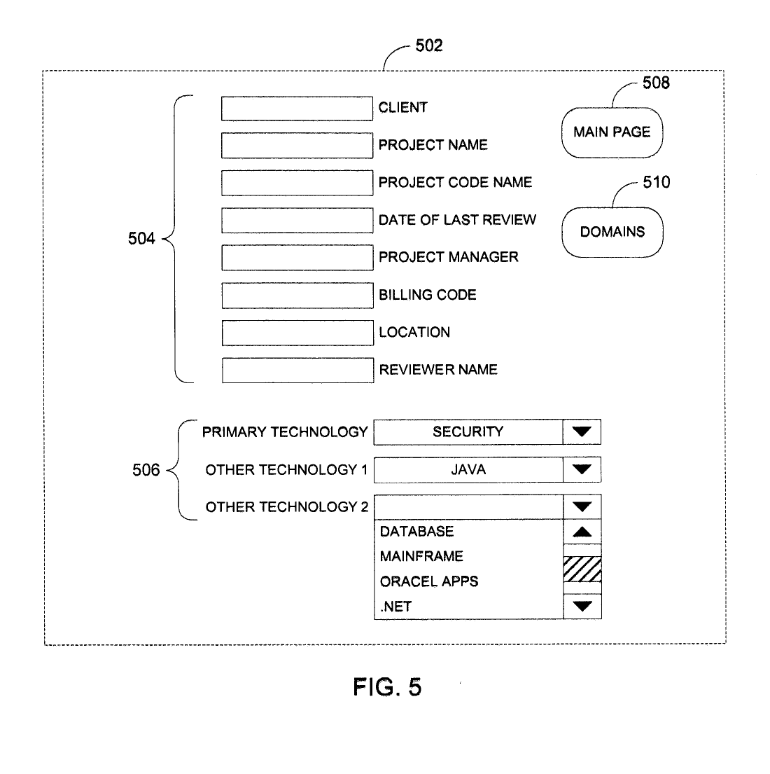

Regardless of the manner in which it is implemented, processing begins at block 202 where project specification data is received. That is, a user (reviewer) provides the project specification data as user-provided input data. The project specification data is used, as described in greater detail below, to select one or more questionnaires that are particularly relevant to the skill sets that are applicable to the project being assessed. Examples of certain types of project specification data are described in further detail below with reference to FIG. 5. Generally, skill sets or domains refer to the specific capabilities that need to be applied to the project in order for the project to be successfully completed. For example, in the context of a software development project, such skill sets may include a specific technology (e.g., database development, web interface development, application layer integration, testing, etc.), process management (e.g., quality assurance, tracking and reporting, etc.) and/or personnel management (e.g., management of individuals and the team as a whole, etc.).

Continuing at block 204, one or more questionnaires are identified based on the project specification data. Each of the at least one questionnaire comprises questions concerning best practices applicable to the at least one skill set corresponding to that questionnaire. In one embodiment, the questions provided in each questionnaire are phrased so as to be answered in a standardized manner. For example, each question may be phrased for a yes/no or true/false responses. Alternatively, numeric or other scales associated with predetermined responses (e.g., “5=strongly agree”, “4=agree”, “3=neutral or no opinion”, “2=disagree” and “1=strongly disagree”) may also be used. Furthermore, the questions presented may be phrased to determine whether best-practices concerning the corresponding skill set are being followed. That is, the “polarity” of the questions can be selected such that an affirmative answer (yes/true or high ranking) indicates that best practices are being followed, whereas a negative answer (no/false or a low ranking) indicates that best practices are not being followed. The content of each question, i.e., what constitutes a best practice for a given skill set, are preferably chosen and vetted by subject matter experts. Such experts may be selected based on their general knowledge concerning the skill set or on their specific knowledge concerning application of the particular skill set within a given environment, e.g., within an organization.

Thereafter, at block 206, the at least one questionnaire is presented to a user. In one embodiment, described in further detail below, the at least one questionnaire is provided to a user via a graphical user interface such as may be implemented using the apparatus 100 described above. However, it will be appreciated that other techniques for presenting a questionnaire to a user may also be employed as a matter of design choice. Regardless of the manner in which the questions are presented, processing continues at block 208 where assessment data, i.e., user-provided input data, is received in response to the presented questionnaires. The assessment data may be provided using any convenient user input device. As noted above, the assessment may take the form of yes/no, true/false, numeric, etc. responses correlated to the questions being presented.

Upon receipt of the assessment data, processing continues at block 210 where one or more scores are determined based on the received assessment data. For example, an overall project score may be determined based on the received assessment data. The overall project score seeks to place a numeric value regarding the overall heart of the project. Thus, in one embodiment, the overall project score may reflect the percentage of affirmatively answered questions relative to the total number of questions, with higher percentages (in the event that the questions are phrased for affirmative answers, as noted above) corresponding to higher levels of adherence to best practices. In a more detailed implementation, skill set sub-scores corresponding to the various skill sets designated within the project specification data may also be determined. In this case, the overall project score may be calculated as a combination (e.g., a straight or weighted average) of the various skill set sub-scores. Conversely, a project impact score may also be determined. The project impact score attempts to quantify the effect of failure to follow best practices within the project and may be determined, for example, based on the percentage of questions answered in the negative (again assuming affirmatively-oriented questions). Those having ordinary skill in the art will appreciate that any of a number of calculations may be used to determine scores of the type described herein, and that the instant disclosure need not be limited in this regard.

Regardless of the techniques used to determine the various scores, processing continues at block 212 where the one or more scores determined at block 210 are presented to the user. Once again, the presentation of the scores may be done via the graphical user interface or any other convenient means. Further still, descriptive evaluations of the project status, which may be correlated to the scores, may also be presented to the user. For example, a textual description associated with a range of overall project scores may be presented when the overall project score falls within that range. Furthermore, other textual or descriptive content may be provided. For example, suggested courses of action or recommendations may be provided based on any of the received assessment data or calculated scores, as described in greater detail below. Further still, various well-known highlighting techniques may be used to emphasize various portions of the resulting display, such as color coding, varying font sizes, font formatting, etc.

Referring now to FIG. 3, a block diagram of a functional implementation is further illustrated. As described above, the functional components illustrated in FIG. 3 may be implemented using the apparatus 100 illustrated in FIG. 1. In particular, each of the components illustrated in FIG. 3 may be implemented using stored, executable instructions that control operation of the processor 102. Techniques for such an implementation are well known to those having ordinary skill in the art of software programming. Of course, it is understood that other implementations may be equally employed as a matter of design choice. Regardless of the particular implementation employed, a user interface component 302 is provided in communication with a questionnaire selection component 304 and a calculation component 308. In turn, the questionnaire selection component 304 is in communication with a database 306.

As shown, the user interface component 302 accepts user input provided by a user, and provides display output (at least in the case of a graphical user interface or other displayed interface). As noted, the user interface component 302 may be implemented as a graphical user interface. However, it is understood that the user interface component 302 may be implemented using other techniques. For example, a text-based interface could be equally employed. Regardless of the particular implementation used, the user interface component 302 provides, in one mode of operation, the user input data 310 to the questionnaire selection component 304. In this instance, the user input 310 embodies project specification data that is representative of a selected questionnaire. (Although not shown, the display data, e.g., the project details page illustrated in FIG. 5, used to solicit the user input that is representative of the project specification data may be provided by the questionnaire selection component 304 or another component, such as a control component, in communication with the user interface component 302.)

The questionnaire selection component 304 uses the user input/project specification data 310 to access the database 306 where the one or more questionnaires are stored. Based on user input 310, one or more particular questionnaires are selected and provided to the user interface component 302 as display data 312. Various techniques may be used to select the one or more questionnaires based on the user input/project specification data 310. For example, that portion of the project specification data corresponding to one or more selected skill sets may be used to index the database 306 to identify the corresponding questionnaires. Regardless of the manner in which the questionnaires (and resulting display data) are identified, the user interface component 302, in turn, renders the display data 312 perceivable by the user of the apparatus.

In response, the user provides assessment data 314 via the user interface component 302, which data is thereafter provided to the calculation component 308. Once again, the particular format of the assessment data is a matter of design choice provided that it is standardized in some fashion to reduce response variability due to individual user characteristics. Thereafter, the calculation component 308 derives the various scores and/or metrics 316 that are subsequently provided to the user interface component 302 for display to the user. Once again, the calculation component 308 may use any of a variety of techniques for calculating the desired scores.

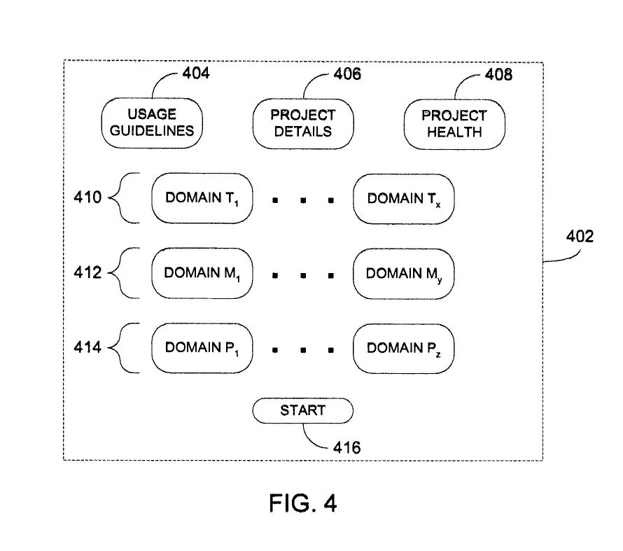

Referring now to FIGS. 4 thru 7, an example of a graphical user interface is described. In particular, the displays illustrated in FIGS. 4-7 are the result of display data provided to a suitable display device. Although particular embodiments are illustrated in FIGS. 4-7, those having ordinary skill in the art will appreciate that other presentation formats, nonetheless equivalent in terms of information presented, may be equally employed and the instant disclosure is not limited in this regard.

Referring now to FIG. 4, a main page display 402 is illustrated. As shown, the main page display 402 comprises a plurality of user selectable buttons 404-416. Although buttons 404-416 are illustrated, it will be appreciated that other input mechanisms, e.g., drop down menus or the like, could also be employed for the purposes described below. In the illustrated embodiment, a usage guideline button 404, a project details button 406 and a project health button 408 are provided along the top of the main page display 402. The usage guidelines button 404 provides the user of the interface with instructions concerning how to navigate through the display screens, answers to frequently asked questions, how to obtain further help, etc. The project details button 406 invokes a project details display 502 (illustrated in FIG. 5) through which a user can enter the project specification data. Using the project health button 408, a user can navigate directly to a presentation based on the previously entered assessment data.

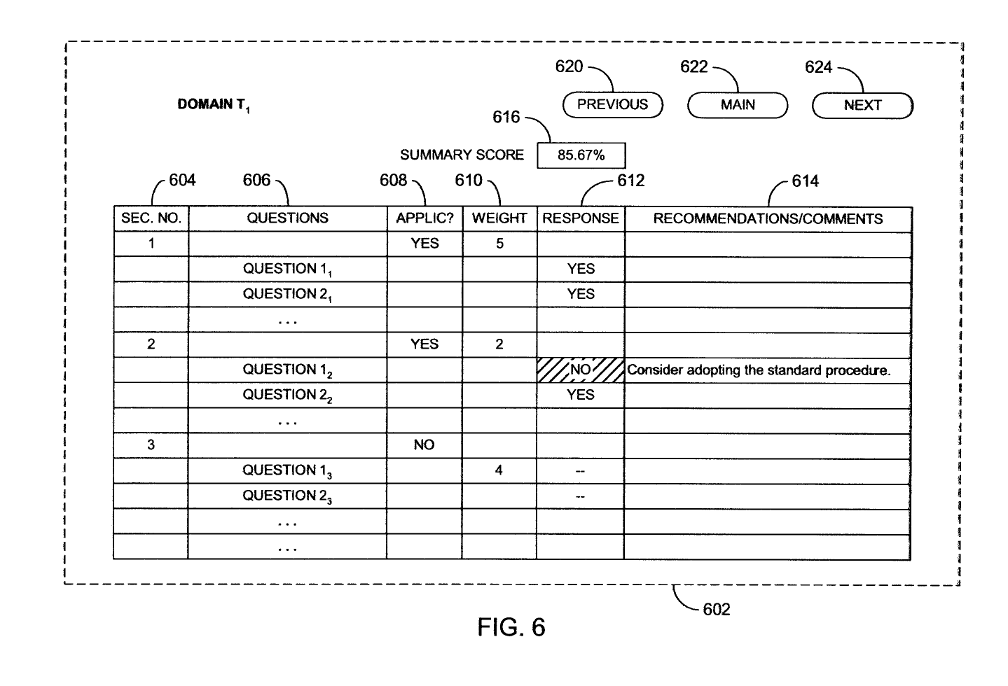

As further shown in FIG. 4, the main page display 402 may also comprise a plurality of buttons 410-414 representative of a variety of generically-labeled skill sets or domains preferably organized according to various categories. For example, as illustrated, a first group of buttons 410 correspond to various technically-related domains labeled T₁ thru T_{X}. Likewise, a second group of buttons 412 correspond to the plurality of project management-related domains labeled M₁ thru M_{Y}. Finally, a third group of buttons 414 corresponding to process-related domains P₁ thru P_{Z}. Selection of any of the domain buttons 410 thru 414 causes redirection to a questionnaire display, an example of which (602) is illustrated below relative to FIG. 6. Generally, each of the generic domains corresponding to the buttons 410-414 will be associated with a specific questionnaire selected according to the project specification data. Thus, for a first set of project specification data, each of the buttons 410-414 will be associated with a first questionnaire whereas, for a second set of project specification data, each of the buttons 410-414 may be associated with either the first questionnaire or second questionnaire, depending on the differences between the first and second sets of project specification data. Although particular groups of buttons 410-414 are illustrated in FIG. 4, it will be appreciated that a greater or less number of buttons may be employed as a matter of design choice. Furthermore, the categories corresponding to the groupings in the illustrated example are not exhaustive of the various possibilities. Finally, a start button 416 is provided that, upon selection, initiates entry of the project specification data through a project details display 502.

Referring now to FIG. 5, the project details page 502 is further illustrated. The project details page 502 is used to enter project-specific data according to various user inputs. In the illustrated example, a variety of user selectable input mechanisms 504, 506 are shown. For example, a plurality of text entry fields 504 are provided. As shown, using the text entry fields 504, a user may provide data representative of a client, a project name, a project code name, a date of last review, a project manager name, a billing code, a location, and a reviewer name. Those having skill in the art will appreciate that the particular text entry fields 504 employed will depend on the nature of the types of projects being analyzed. By using the text entry fields 504 for this purpose, the user is provided great flexibility in determining the manner in which specific projects are identified and tracked. As further shown, a plurality of pull down menus 506 are also provided for designating the skill sets or domains relevant to the project to be reviewed. As shown, the pull down menus 506 are divided into “primary technology” and “other technology” pull down menus. By using pull down menus in this manner, a user is restricted to the specific input choices programmed into the pull down menu. This allows specific questionnaires to be developed corresponding to the various primary and secondary technologies. For example, in the illustrated example, the primary technology pull down menu has been used to select “security” as the primary technology for the project being reviewed, whereas the first other technology pull down menu has been used to select Java as another relevant technology. Further examples of other relevant technology skill sets are also shown in the illustrated example. Although specific text entry fields 504 and pull down menus 506 are illustrated in FIG. 5, the instant disclosure is not so limited. That is, a greater or less number of input mechanisms 504, 506 may be employed as needed, and the specific types of project specification data obtained may also vary as a matter of design choice.

Referring now to FIG. 6, an example of a questionnaire display 602 is illustrated. As described above, the questionnaire display 602 may be accessed through selection of one of the corresponding domain buttons. For example, in the illustrated example, the questionnaire display 602 corresponds to the domain labeled T₁. Within the questionnaire display 602, domain specific questions 606 are organized according to a plurality of sections 604. Each section 604 may delineate a given sub-topic relevant to best practices for the given domain. As noted above, each of the questions 606 is designed to elicit standardized assessment data that may be used to evaluate project performance relative to the selected domain. The content of the specific questions 606 illustrated in a given questionnaire display 602 is dictated, as described above, by the project specification data previously provided, particularly the skill sets designated therein.

In an embodiment, switching inputs 608 are also provided that allow all of the questions 606 corresponding to the various sections 604 to be included or excluded from the assessment as a matter of design choice. That is, some questions 606 may not be applicable to a particular project, and the switching inputs 608 allow them to be excluded if desired. Although, in the illustrated example, the switching inputs 608 are used to control the applicability of entire sections of questions, it is understood that some other level of control, e.g., on a per question basis, may also be employed. In a similar vein, various weights 610 may be applied to each of the illustrated sections 604. Thus, the relevance of the questions 606 to a given project, particularly to the extent that the resulting assessment data effects the assessment results, may be more finely controlled. For example, higher-valued weights may correspond to increasingly important or relevant questions, whereas lower-valued weights correspond to relatively less important or relevant questions.

Input mechanisms 612 are provided to allow a user of the questionnaire display 602 to enter their responses. In the illustrated example, yes/no responses are allowed, which responses may be entered as straight text. However, those having ordinary skill in the art will appreciate that other types of responses might be allowed. Additionally, other types of input mechanisms, e.g., pull down menus, may be equally employed. In an embodiment, a recommendation/comment section 614 is provided for each of the various questions 606. This section 614, embodied as text input fields, allows the user to explain his or her response 612 in greater detail, particularly in the case where the answer to a given question is in the negative.

As further shown, a skill set or domain sub-score output 616 is provided. The skill set sub-score 616 expresses a relative level of compliance with the best practices corresponding to the domain as embodied by the various questions 606. For example, in one embodiment, the skill set sub-score 616 is calculated as a weighted percentage (based on the weights 610) of the total number of questions 606 answered in the affirmative. Those having ordinary skill in the art will appreciate that other techniques for calculating the skill set sub-score 616 may be equally employed, and that the instant disclosure is not limited in this regard.

As further shown, various navigation buttons 620-624 are also provided. In particular, a previous button 620 allows a user to navigate to the previous display page, in one embodiment, the project details display 502. In a similar vein, a next page button 624 allows a user to navigate to the next available page, in one embodiment, another questionnaire display. Finally, the main button 622 allows a user to navigate to the main page display 402. Of course, those of skill in the art will appreciate that the function of the buttons 620-624 may be replaced with similar input mechanisms, such as a single pull down menu, etc.

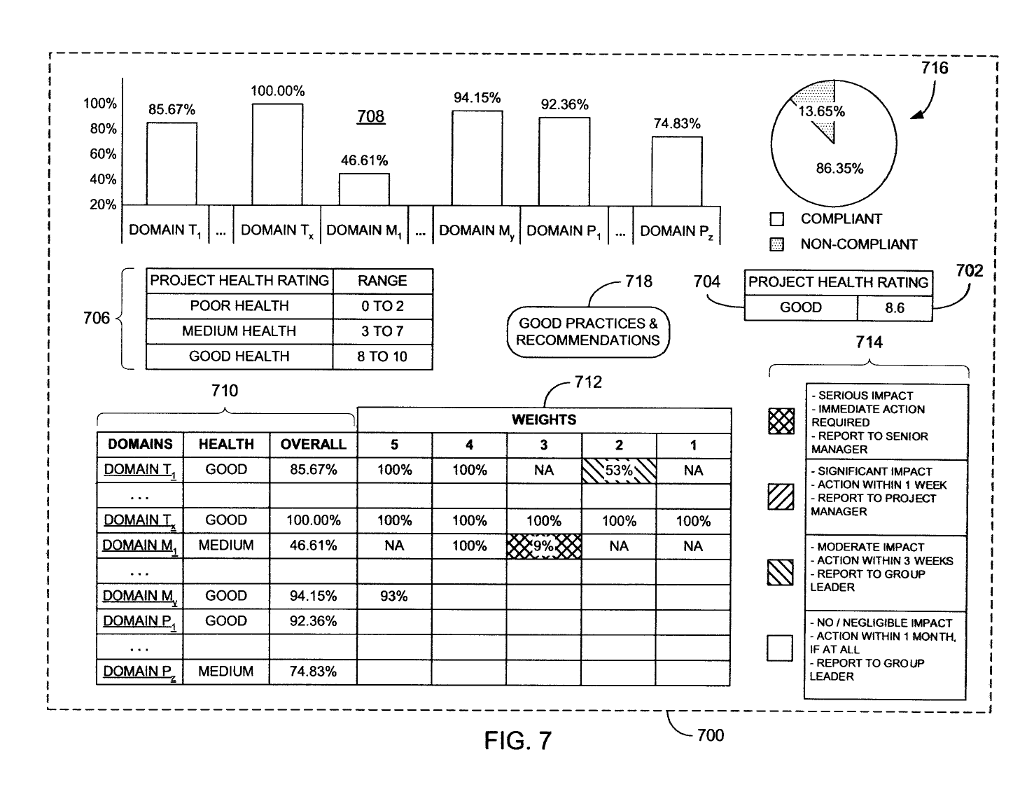

Referring now to FIG. 7, a presentation display 700 is further illustrated. In one embodiment, a user can navigate to the presentation display 700 by selecting either of the project health button 408 or through completion of all of the questionnaires 602 followed by selection of the next page button 624 displayed on the last questionnaire. Regardless, the presentation display 700 may include an overall project score 702 that is calculated based on the assessment data received in response to the one or more questionnaires, as described above. Likewise, a descriptive assessment 704 corresponding to the overall project score 702 may also be provided. In this manner, the presentation page allows a user to quickly ascertain the overall “project health” rating for the given project. Optionally, a descriptive assessment legend 706 may also be provided which provides a user with various ranges for the overall project score 702 and the corresponding descriptive assessment 704.

As further shown, each of these skill sets or domains may have a corresponding skill set sub-score illustrated; in this example, a plurality of bar graphs 708 are employed. Each of the skill set sub-scores 708 may be further broken down in a details section 710 as shown. Within the details section 710, each domain is shown with, in one embodiment, the titles of each domain being selectable (using, for example, hyperlinks) to allow a user to navigate back to the questionnaire display corresponding to that skill set/domain. Likewise, the skill set sub-scores and corresponding descriptions may also be shown in the details section 710.

In addition to the detail section 710, each skill set or domain is also presented along with its degree of best practices compliance 712 as determined by the various weights described above. In an embodiment, the percentages displayed in the best practices compliance section 712 are the scores from each of the domains that take into account the assigned weights (610). This assists in analyzing the weight-wise compliance scores of each domain to focus attention on any potential problem areas. A further indicator 716 may also be provided illustrating the level of compliance and non-compliance (relative to best practices) of the project overall. Finally, a good practices and recommendations button 718 may be provided that, when selected, provides more detailed explanation of the good practices and recommendations corresponding to each of the illustrated domains. In particular, the recommendations/comments 614 provided by reviewers via the questionnaire displays 602 may be summarized and displayed by selection of the good practices and recommendations button 718.

As described above, the instant disclosure sets forth various techniques for performing project reviews in a repeatable, reliable and automated fashion. This is achieved through the use of user-provided project specification data that, in turn causes the selection and subsequent presentation of one or more questionnaires concerning best practices most relevant to the project under consideration. Because the questionnaires are phrased in such a manner as to require standardized responses, the variability of prior art techniques may be avoided. Furthermore, because the questionnaires are formulated based on best practices for specific skill sets, reviewer interpretation of the questions is minimized and the assessment data received thereby at least inherently suggests solutions to any identified problems. For at least these reasons, the above-described techniques represent an advancement over prior art teachings.

While particular preferred embodiments have been shown and described, it will be obvious to those skilled in the art that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. A method for assessing a project, the method comprising:
receiving project specification data descriptive of at least one skill set applied to the project;
identifying at least one questionnaire based on the project specification data, the at least one questionnaire comprising questions concerning best practices applicable to the at least one skill set;
presenting the at least one questionnaire to a user via a graphical user interface; and
receiving assessment data in response to the at least one questionnaire.

2. The method of claim 1, further comprising:
determining an overall project score based on the assessment data; and
presenting the overall project score via the graphical user interface.

3. The method of claim 2, wherein each of the at least one skill set has at least one corresponding weight applied thereto, and further comprising:
determining the overall project score based on the assessment data, wherein that portion of the assessment data corresponding to each of the at least one skill is weighted according to the at least one corresponding weight.

4. The method of claim 2, further comprising:
determining a descriptive assessment of the project based on the overall project score; and
presenting the descriptive assessment via the graphical user interface.

5. The method of claim 1, wherein the project specification data descriptive of the at least one skill set comprises at least one identification of a specific technology applied to the project.

6. The method of claim 1, further comprising:
determining, for each of the at least one skill set, a skill set sub-score based on that portion of the assessment data corresponding to the skill set; and
presenting, for each of the at least one skill set, the skill set sub-score via the graphical user interface.

7. The method of claim 1, further comprising:
determining a project impact score based on that portion of the assessment data indicative of failure to follow the best practices; and
presenting the project impact metric via the graphical user interface.

8. An apparatus for assessing a project, comprising:
at least one processor;
a display in communication with the at least one processor;
at least one user input device in communication with the at least one processor;
at least one storage device in communication with the at least one processor and having stored thereon instructions that, when executed by the at least one processor, cause the at least one processor to:
receive, via the at least one user input device, project specification data descriptive of at least one skill set applied to the project;
identify at least one questionnaire based on the project specification data, the at least one questionnaire comprising questions concerning best practices applicable to the at least one skill set;
present the at least one questionnaire to a user via the display; and
receiving assessment data in response to the at least one questionnaire via the at least one user input device.

9. The apparatus of claim 8, wherein the at least one storage device further comprises instructions that, when executed by the at least one processor, cause the at least one processor to:
determine an overall project score based on the assessment data; and
present the overall project score via the display.

10. The apparatus of claim 9, wherein each of the at least one skill set has at least one corresponding weight applied thereto, and wherein the at least one storage device further comprises instructions that, when executed by the at least one processor, cause the at least one processor to:
determine the overall project score based on the assessment data, wherein that portion of the assessment data corresponding to each of the at least one skill is weighted according to the at least one corresponding weight.

11. The apparatus of claim 9, wherein the at least one storage device further comprises instructions that, when executed by the at least one processor, cause the at least one processor to:
determine a descriptive assessment of the project based on the overall project score; and
present the descriptive assessment via the display.

12. The apparatus of claim 8, wherein the project specification data descriptive of the at least one skill set comprises at least one identification of a specific technology applied to the project.

13. The apparatus of claim 8, wherein the at least one storage device further comprises instructions that, when executed by the at least one processor, cause the at least one processor to:
determine, for each of the at least one skill set, a skill set sub-score based on that portion of the assessment data corresponding to the skill set; and
present, for each of the at least one skill set, the skill set sub-score via the display.

14. The apparatus of claim 8, wherein the at least one storage device further comprises instructions that, when executed by the at least one processor, cause the at least one processor to:
determine a project impact score based on that portion of the assessment data indicative of failure to follow the best practices; and
present the project impact metric via the display.

15. An apparatus for assessing a project, comprising:
a user interface component;
a questionnaire selection component, in communication with the user interface component, operative to receive project specification data descriptive of at least one skill set applied to the project and, in response to the project specification data, provide at least one questionnaire to the user interface component; and
a calculation component, in communication with the user interface component, operative to receive assessment data from the user interface component in response to the at least one questionnaire and determine an overall project score based on the assessment data.

16. The apparatus of claim 15, further comprising:
a database, in communication with the questionnaire selection component, having stored thereon a plurality of questionnaires each comprising questions concerning best practices applicable to at least one skill set.

17. The apparatus of claim 15, wherein the calculation component is further operative to provide the overall project score to the user interface component.
